(19) United States
(12) Patent Application Publication
(10) Pub. No.: US 2018/0186963 A1
(43) Pub. Date: Jul. 5, 2018

(54) METHODS FOR RECLAIMING OR RECYCLING ASPHALT AND ASPHALT AND ASPHALT COMPONENTS PRODUCED THEREBY

(71) Applicants: Stojan Kotefski, Bloomingdale, NJ (US); Michael Fitzpatrick, Bloomingdale, NJ (US); Kevin Thomas Fitzpatrick, Bloomingdale, NJ (US); Michelle Kotevska, Bloomingdale, NJ (US); Kailey Marie Fitzpatrick, Bloomingdale, NJ (US)

(72) Inventors: Stojan Kotefski, Bloomingdale, NJ (US); Michael Fitzpatrick, Bloomingdale, NJ (US); Kevin Thomas Fitzpatrick, Bloomingdale, NJ (US); Michelle Kotevska, Bloomingdale, NJ (US); Kailey Marie Fitzpatrick, Bloomingdale, NJ (US)

(21) Appl. No.: 15/395,298

(22) Filed: Dec. 30, 2016

(51) Int. Cl. C08J 11/08; C08L 95/00; C10C 3/00

(52) U.S. Cl. CPC C08J 11/08; C08L 95/00; C08L 2555/34; C08J 2395/00; C10C 3/007

(57) ABSTRACT

A method to reclaim or recycle asphalt or asphalt components to produce reusable asphalt or asphalt components featuring (a) providing crushed asphalt or asphalt components, and (b) adding the asphalt or asphalt components to a solvent in which the asphalt binder is soluble. The solvent may be at approximately ambient temperature and may be, for instance, heptane, hexane, naphta, kerosene, gasoline or a petroleum based solvent or any other suitable solvent in which the asphalt binder is soluble. The solvent may be added in a standard automated parts washer or equivalent equipment to provide exposure to one or more solvents in which the asphalt binder is soluble. The method may further feature c) grinding or breaking the asphalt to be reclaimed or recycled into chunks, millings or particulate prior to step a), d) screening or separating coarse aggregate and fine aggregate asphalt components from the solution of b), d) cleaning or removing asphalt binder and/or the solution from the coarse aggregate and fine aggregate asphalt components screened or separated in step c), and e) cleaning or removing asphalt binder from the solution of b).

### FIELD OF THE INVENTION

The present invention is in the field of asphalt reclamation and recycling. Specifically, the present invention provides methods for recycling asphalt as well as the recycled asphalt components.

### BACKGROUND OF THE INVENTION

Asphalt is a universal raw material used for roadways, parking lots and other surface treatments. The asphalt material is generally a composition of minerals including aggregate and sand or stone dust and an asphalt binder. Additionally, novel asphalt mixtures include various substitutes for the aggregate (coarse and fine) including; crushed glass, used tires, and other reclaimed materials. The asphalt binder is basically the glue that binds the mineral ingredients such that they are solid under normal operating or environmental temperatures but semi-liquid under elevated temperatures. Another product related to the commonly known term as asphalt is roofing shingles, composed of similar components including aggregate, asphalt binder, and fiberglass.

A typical asphalt composition contains a general ratio of materials as follows: coarse aggregate including crushed minerals or stone having particle sizes in the range from about ⅛ to 1 inch, 70-85%, fine aggregate including compositions of crushed stone dust, crushed glass, sand or other small sized filler, 10-20%, asphalt binder, a blend of petroleum refinery product (byproduct) that can be further modified to achieve certain asphalt mixtures or grades, about 10%, and miscellaneous ingredients including trapped air (voids) and moisture. A typical asphalt mixture is the blending of the coarse and fine aggregate with the asphalt binder. However, in the blending process, some trapped air is normally also included. The amount of trapped air and the coating and bonding of the asphalt binder to the aggregate determines the quality and grade of the final asphalt product. As these materials are mixed, the asphalt composition is subjected to elevated temperature (about 300-400° F.) and uniformly mixed such that a uniform blending of components is achieved. This hot mixture is bonded by the phase change of the asphalt binder from a solid to a semi-liquid. As the semi-liquid asphalt mixture coats the course and fine aggregates, the final asphalt mixture is blended to meet the requirements of the needed final product.

Certain asphalt mixtures are required to meet Department of Transportation specifications based upon application location, environmental and temperature ranges and other requirements. The various grades of asphalt are based upon the aggregate size (coarse and fine), content and percentages of the added components including binder. These asphalt grades created by their respective asphalt binders, screened aggregate particle sizes, compaction forces on the mixture and vibratory rolling to further orientate the final asphalt composition prior to solidification.

As the asphalt is applied to a surface and rolled so that the final flat surface is achieved, other variables are introduced that can affect asphalt quality. These variables or conditions include surface temperatures, asphalt temperatures, application thicknesses and other application variables that may affect the final grade of the asphalt achieved. The asphalt mixture applied is a form of thermo plastic that solidifies as the temperature is reduced from the asphalt blending temperature (300-400° F.) to the final product application temperatures (−60 to 160° F.). These temperature ranges affect the temperature change rate or thermal gradient of the solidification process and this affects the final product compaction ratio, density and mechanical properties. The final asphalt product performance factors are based upon these components, the mixture ratios and application methods.

The asphalt binder is phase changed from a solid at ambient temperatures to a semi liquid at elevated temperatures (a plastic state or high viscosity state) that coats the coarse and fine aggregates and fills the voids of the mixture. Aggregate uniformity coating issues occur with the semi liquid asphalt binder because it cannot be thoroughly liquid. After a certain elevation in temperature, the asphalt binder burns or degrades. This aggregate coating capability is an important aspect of achieving higher grade asphalts. It would be desirable to coat the aggregate in an improved manner.

Once an asphalt mixture is applied and rolled onto a desired surface (roadway, parking lot driveway, etc.), the lower temperature of the contact surface changes the asphalt binder back from a semi-liquid state to a solid. This becomes the desired asphalt final product. The coarse and fine aggregate compositions, mixture ratios and asphalt binder blends may further improve the asphalt mixture and final asphalt product properties that may provide an improved life cycle, operating temperature exposure characteristics, weight load bearing properties, surface coefficient of friction characteristics and other desired properties.

The current methods for recycling asphalt typically take certain percentages of “millings” or scrapped/salvaged asphalt from an existing, aged or degraded asphalt surface and blend a small percentage of these millings into a virgin mixture of asphalt (a blend of 25% millings to 75% virgin asphalt is a normal practice). These recycling methods provide a means of recovering small percentages of the “used” or “salvaged” asphalt for recycling back into a new asphalt. As a general rule, approximately 10-30% of millings can remixed with virgin asphalt. This is because the new asphalt mixture is degraded with the addition of aged millings because it does not blend as uniformly as virgin materials. This practice is not allowed in some jurisdictions (approximately 22 States have banned this process) because the new asphalt mixture (with the recycled asphalt content) is inferior. This is likely the result of the aged asphalt having asphalt binder in a crystalline state that cannot phase change or liquefy as the virgin asphalt binder and thus cannot completely blend into the mixture. This yields a lower grade asphalt mixture that has limited use such applications as parking lots and driveways.

Elseifi et al., U.S. Patent Publication 2014/0299018 teach a process for separating constituents of an asphalt-based material including at least asphalt and one solid non-asphalt material by shredding the asphalt-based material to form a shredded material mass. Next, an asphalt binder at an elevated temperature is added to absorb the recoverable asphalt binder from the shredded material. This produces a 30-40% increase in the binder volume, i.e. the recovered binder from the shredded material.

Kotefski et al., U.S. Ser. No. 15/355,487, filed Nov. 18, 2016, the disclosure of which is herein incorporated by reference, teach methods to reclaim or recycle asphalt or asphalt components to produce reusable asphalt or asphalt components by adding the asphalt or asphalt components to a solution at a temperature higher than the melting temperature of the asphalt binder. The solution may be at least 300° F., 325° F., 350° F. or 400° F. or so, and the solution may be an oil or petroleum based solution or any other suitable solution in which the asphalt binder is soluble. In some instances, the solution may be virgin motor oil or recycled motor oil. It is desirable to provide new and improved methods to reclaim or recycle asphalt to produce reusable asphalt and asphalt components. Preferably, reusable asphalt and asphalt components have the physical properties of virgin asphalt.

It is also desirable to provide further improved methods to reclaim or recycle asphalt or asphalt components to produce reusable asphalt or asphalt components.

### SUMMARY OF THE INVENTION

In a first aspect, the invention provides a method to reclaim or recycle asphalt or asphalt components to produce reusable asphalt or asphalt components featuring
(a) providing crushed asphalt or asphalt components, and
(b) adding the asphalt or asphalt components to a solvent in which the asphalt binder is soluble.

The solvent may be at approximately ambient temperature, for instance, of 50-100° F., or 60-90° F., or 70-80° F. or so. The solvent may be, for instance, heptane, hexane, naphta, kerosene, gasoline or a petroleum based solvent or any other suitable solvent in which the asphalt binder is soluble. The solvent may be added in a standard automated parts washer or equivalent equipment to provide exposure to one or more solvents in which the asphalt binder is soluble. The asphalt binder may be in a solid state, and the solvent may be provided in a liquid or gaseous state. Materials in a first slurry mass include solid materials (aggregate coated with residual binder) and solvent/asphalt binder. The solid materials (aggregate coated with residual binder) may be separated via a screening operation while the solvent and asphalt binder can be further treated. The solvent and the asphalt binder in the final asphalt binder-solvent solution may then be further separated to form a reclaimed solvent mass and an asphalt binder mass.

The method may further feature crushing, grinding or breaking the asphalt to be reclaimed or recycled into chunks, millings or particulates prior to step a) above.

The method may further feature c) screening or separating coarse aggregate and fine aggregate asphalt components from the solution of b).

The method may further feature d) cleaning or removing asphalt binder and/or the solution from the coarse aggregate and fine aggregate asphalt components screened or separated in step c). The cleaning or removing asphalt binder and/or the solution from the coarse aggregate and fine aggregate asphalt components may be performed by evaporation, centrifugal spinning or by adding a second solution effective to remove the asphalt binder and/or the first solution.

The method may further feature e) cleaning or removing asphalt binder from the solution of b). This may also be performed in an automated parts washer. The automated parts washer may be useful for washing and reclaiming the solvent.

The methods may be effective to remove 10%, 20%, 25%, 30%, 40%, 50%, 60%, 75% or more of the asphalt binder from the surfaces of the coarse aggregate or fine aggregate asphalt components.

In a second aspect, the invention provides asphalt or an asphalt component reclaimed or recycled according to the methods described herein. The asphalt component may be one or more of a coarse or mineral aggregate, a fine aggregate and an asphalt binder. The asphalt binder may be present in, for instance, conventional asphalt, roofing shingles, roofing paper, driveway patch mixes, crack sealers, etc. The reclaimed or recycled asphalt or asphalt component may have the physical properties of virgin asphalt or may feature binding properties such as binding to an asphalt binder that is superior to the binding properties of virgin asphalt or virgin asphalt components.

The coarse or mineral aggregate may include crushed minerals or stones having particle sizes in the range from about ⅛ to 1 inch in diameter. The coarse or mineral aggregate may be substantially coated with asphalt binder or substantially coated with a suitable solution in which the asphalt binder is soluble. The coating may be substantially uniform or non-uniform, and the coating may be at a thickness of, for instance, about 1, 2, 3, 4, 5, 10, 25, 50, 100 or 200 μm or more.

The fine aggregate may include compositions of crushed stone dust, crushed glass, sand or other small sized filler having a diameter of about ¼, or ⅛ or 1/10 or 1/100 inch or less. The fine aggregate may be substantially coated with asphalt binder or substantially coated with a suitable solution in which the asphalt binder is soluble. The coating may be substantially uniform or non-uniform, and the coating may be at a thickness of, for instance, about 1, 2, 3, 4, 5, 10, 25, 50, 100 or 200 μm or more.

The asphalt binder may be a solid at room temperature. The asphalt binder may be present as a liquid that is dissolved in a suitable solution in which the asphalt binder is soluble.

In a third aspect, the invention provides a reclaimed or recycled asphalt or asphalt component. The asphalt component may be one or more of a coarse or mineral aggregate, a fine aggregate and an asphalt binder. The asphalt binder may be present in, for instance, conventional asphalt, roofing shingles, roofing paper, driveway patch mixes, crack sealers, etc. The reclaimed or recycled asphalt or asphalt component may have the physical properties of virgin asphalt or may feature binding properties such as binding to an asphalt binder that is superior to the binding properties of virgin asphalt or virgin asphalt components.

The coarse or mineral aggregate may include crushed minerals or stones having particle sizes in the range from about ⅛ to 1 inch in diameter. The coarse or mineral aggregate may be substantially coated with asphalt binder or substantially coated with a suitable solution in which the asphalt binder is soluble. The coating may be substantially uniform or non-uniform, and the coating may be at a thickness of, for instance, about 1, 2, 3, 4, 5, 10, 25, 50, 100 or 200 μm or more.

The fine aggregate may include compositions of crushed stone dust, crushed glass, sand or other small sized filler having a diameter of about ¼, or ⅛ or 1/10, or 1/100 inch or less. The fine aggregate may be substantially coated with asphalt binder or substantially coated with a suitable solution in which the asphalt binder is soluble. The coating may be substantially uniform or non-uniform, and the coating may be at a thickness of, for instance, about 1, 2, 3, 4, 5, 10, 25, 50, 100 or 200 μm or more.

The asphalt binder may be a solid at room temperature. The asphalt binder may be present as a liquid that is dissolved in a suitable solution in which the asphalt binder is soluble.

In a fourth aspect, the invention provides a two step integrated method to reclaim or recycle asphalt or asphalt components to produce reusable asphalt or asphalt components using two distinct solvents or solutions for dissolving asphalt binder featuring
(a) providing crushed asphalt or asphalt components, and
(b) adding the asphalt or asphalt components to a solution containing a solvent in which the asphalt binder is soluble.

The solvent may be at approximately ambient temperature, for instance, 50-100° F., or 60-90° F., or 70-80° F. or so. The solvent may be, for instance, heptane, hexane, naphta, kerosene, gasoline or a petroleum based solvent or any other suitable solvent in which the asphalt binder is soluble. The solvent may be added in a standard automated parts washer or equivalent equipment to provide exposure to one or more solvents in which the asphalt binder is soluble. The asphalt binder may be in a solid state, and the solvent may be provided in a liquid or gaseous state. Materials in a first slurry mass include solid materials (aggregate coated with residual binder) and solvent/asphalt binder. The solid materials (aggregate coated with residual binder) may be separated via a screening operation while the solvent and asphalt binder can be further treated. The solvent and the asphalt binder in the final asphalt binder-solvent solution may then be further separated to form a reclaimed solvent mass and an asphalt binder mass.

The solvent may be effective to remove 10%, 20%, 25%, 30%, 40%, 50%, 60%, 75% or more of the asphalt binder from the surfaces of the coarse aggregate or fine aggregate asphalt components.

The method may further feature crushing, grinding or breaking the asphalt to be reclaimed or recycled into chunks, millings or particulate prior to step a) above.

The method may further feature c) screening or separating coarse aggregate and fine aggregate asphalt components from the solution of b).

The method may further feature d) cleaning or removing asphalt binder and/or the solution from the coarse aggregate and fine aggregate asphalt components screened or separated in step c). The cleaning or removing asphalt binder and/or the solution from the coarse aggregate and fine aggregate asphalt components may be performed by centrifugal spinning or by adding a second solution effective to remove the asphalt binder and/or the first solution.

The method may further feature e) cleaning or removing asphalt binder from the solution of b). This may also be performed in an automated parts washer suitable for using solvents and for separating solvents and the asphalt binder.

The method may further feature f) adding the asphalt components obtained from c) or d) to a solution at a temperature higher than the melting temperature of the asphalt binder.

The solution may be at least 300° F., 325° F., 350° F. or 400° F. or so. The solution may be an oil or petroleum base solution or any other suitable solution in which the asphalt binder is soluble. In some instances, the solution may be virgin motor oil or recycled motor oil.

The solution may be effective to remove 40%, 50%, 60%, 75%, 90% or more of the remaining asphalt binder from the surfaces of the coarse aggregate or fine aggregate asphalt components.

The method may further feature g) screening or separating coarse aggregate and fine aggregate asphalt components from the solution of f).

The method may further feature h) cleaning or removing asphalt binder and/or the solution from the coarse aggregate and fine aggregate asphalt components screened or separated in step g). The cleaning or removing asphalt binder and/or the solution from the coarse aggregate and fine aggregate asphalt components may be performed by centrifugal spinning or by adding a second solution effective to remove the asphalt binder and/or the first solution.

The method may further feature i) cleaning or removing asphalt binder from the solution of f).

### BRIEF DESCRIPTION OF THE FIGURES

FIG. 1 illustrates a typical cross section of an asphalt mixture showing the coarse or mineral aggregate 1, fine aggregate 2 and asphalt binder 3.

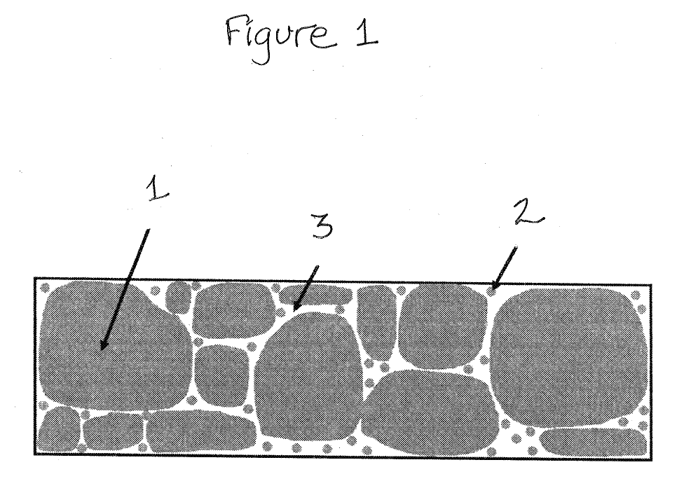

FIG. 2 illustrates a typical chunk of an asphalt mixture containing the coarse or mineral aggregate 1, fine aggregate 2 and asphalt binder 3.

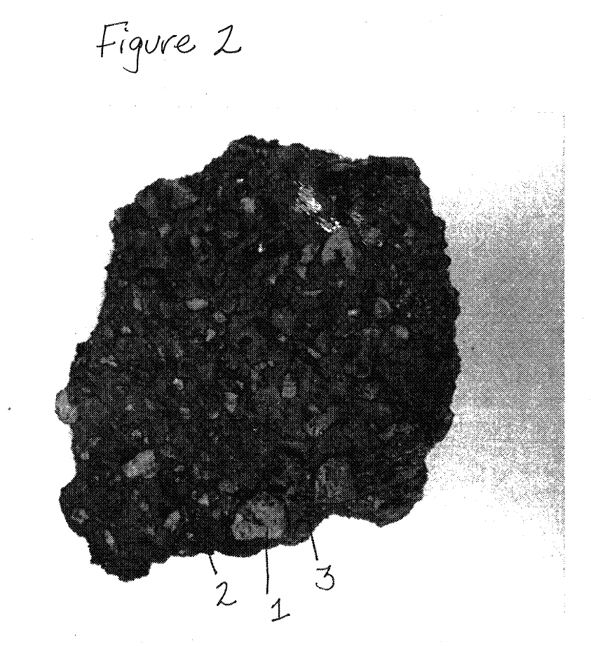

FIG. 3 illustrates the coarse or mineral aggregate 1 coated with solution.

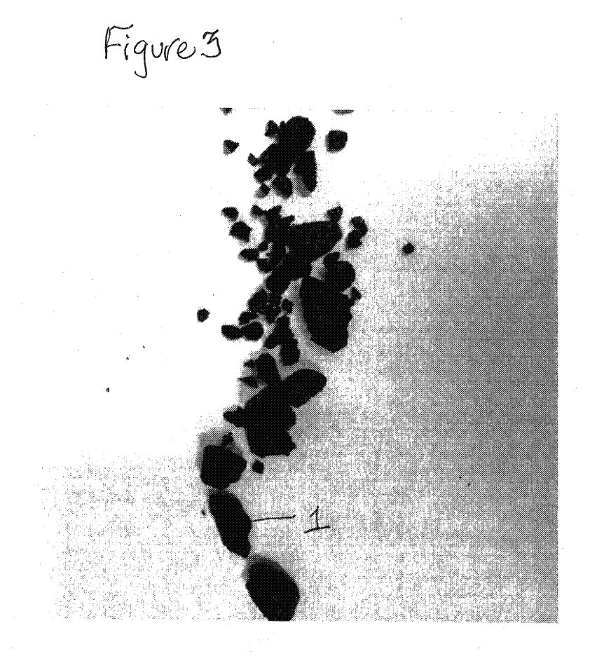

FIG. 4 illustrates the coarse or mineral aggregate 1 substantially free of any coating with asphalt binder.

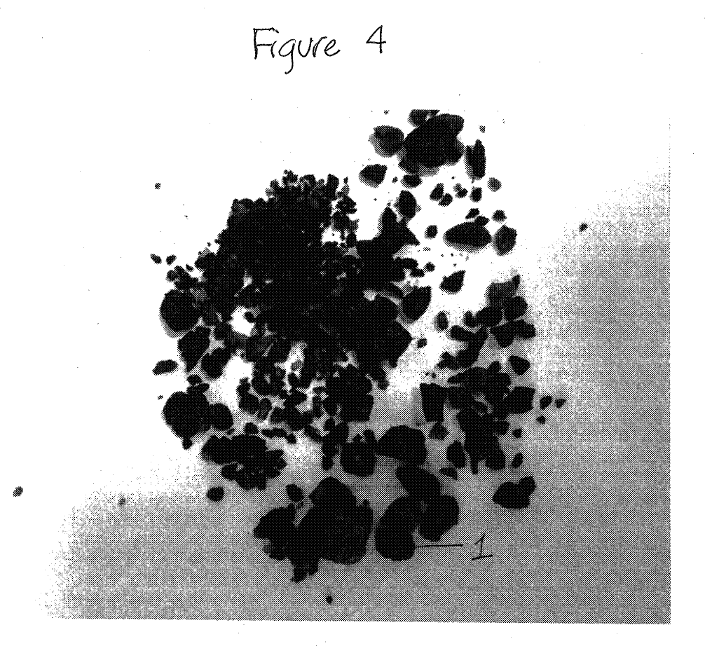

### DETAILED DESCRIPTION OF THE INVENTION

### The Methods

The methods described herein are useful for recycling asphalt and asphalt components. The methods described herein are also useful for breaking down the asphalt mixture into its individual aggregate composition so that the asphalt binder is mechanically broken thereby exposing the aggregate surface area for a second solvent cleaning procedure. In the industry, this may be equivalent to a “crushing” operation which breaks the asphalt binder supporting each aggregate particulate in the asphalt. Also, other commercial methods are available for such a “crushing” procedure including various agitation, compression, clamping, vibration and oscillation equipment.

The first solvent cleaning procedure (performed in a standard automated parts washer, such as those offered by PRI (Progressive Recovery, Inc., Dupo, Ill.) or equivalent equipment provides exposure to one or more solvents in which the asphalt binder is soluble. The asphalt binder is in a solid state, and the solvent is provided in a liquid or gaseous state. As the solvent disperses about the aggregate surface area, loose, broken edges and other forms of asphalt binder are dissolved into the solvent and a binder/solvent mixture is created. This solvent/binder mixture includes the asphalt binder that was small enough or loose enough to be carried into the binder/solution mixture. The amount of asphalt binder able to dissolve into the solvent is based upon the “crushing” procedure and how much the crushing procedure can break down the asphalt binder bond to the aggregate. The finer the breakdown, the more broken asphalt binder surface area is exposed.

The more aggregate surface area exposed, the more the solvent is able to break down the aggregate asphalt binder coated surfaces and loose asphalt binder particulate. The solvent may be provided using an industrial automated parts washer. Such automated parts washers are designed for commodities other than asphalt aggregate such as, for instance, painted parts, degreasing parts, component surface preparations, etc. An automated parts washer may be retrofitted for solvent cleaning of the asphalt after the crushing procedure. In general, the “fluffier” the crushed asphalt aggregate, the more surface area is exposed for the solvent to recover into the asphalt binder/solvent mixture.

In addition to the washing the aggregate and creating the binder/solvent mixture, the automated parts washer recycles the solvent via standard or known condensation methods. The residual of the binder/solvent mixture, i.e. the asphalt binder is recovered as a byproduct of the automated parts washing procedure.

Thus, the methods described herein allow separating the asphalt binder from the binder/solvent mixture. This has not previously been performed and provides a novel separation method normally able to extract about 25-50% of the asphalt binder present on the surface of the “asphalt millings.” The remainder of the asphalt binder remains as a coating on the asphalt aggregate.

The solvent in the methods described herein is one that degrades or allows the asphalt binder to dissolve into the solvent to create the asphalt binder/solvent mixture. Suitable solvents include, for instance, heptane, hexane, naphta, kerosene, gasoline and other petroleum based solvents. These are commercially available solvents, and based upon the solvent aggressiveness desired, the solvent can be suitably selected. Heptane is especially suitable as a solvent, and it is a commonly used as a solvent in the automated parts washing equipment.

### The Products Produced by the Methods

As the Automated Parts Washer cleanses the asphalt aggregate, secondary screening operations may separate the aggregate into sized particulates. Each sized particulate may be remixed with a new asphalt mixture to provide improved asphalt mixture physical properties.

Binder Coated Coarse Aggregate. Large and medium sized aggregate with a significant asphalt binder coating may be obtained. Each large and medium aggregate is coated with the residual asphalt binder that was not removed from the solvent cleaning operation performed in the automated parts washer. Thus, asphalt binder coated aggregate from the used asphalt millings are provided.

Binder Coated Fine Aggregate. These fine aggregate particulates are of special value in the asphalt industry. They may be used directly in other products such as crack fillers, asphalt repair mixtures, surface texture treatments, etc. These fine aggregates are the sand and stone dust of asphalt. They are the smaller particulate of the aggregate composition and are the most difficult to uniformly coat with asphalt binder. This product was not previously available as a stand-alone commodity. Thus, the methods described herein provide asphalt binder coated fine aggregate, a new commodity, useful in the asphalt, roofing, surface texture and other applications.

Binder/Solvent Sludge from the Automated Parts Washer. As the crushed aggregate is washed in the automated parts washer, the residual asphalt binder/solvent sludge is further processed by the automated parts washer. This is a standard solvent washing process in which the solvent is evaporated from the binder/solvent sludge, and the solvent is reclaimed via cooling coils and liquefied for reuse. The remaining binder/solvent mixture component is asphalt binder. Thus, the methods described herein provide for recovering asphalt binder. This asphalt binder may have small traces of the solvent. Hence, the asphalt binder may be further processed to purify the asphalt binder into the desired asphalt binder grade or mixture.

### Other Applications for the Methods Described Herein

The methods described herein may also be used for recycling roofing shingles or other products containing asphalt or asphalt binder. Used or discarded roofing shingles may be shredded into small pieces to expose as much surface area of the roofing shingle asphalt binder. Then as with the asphalt or HMA, the automated parts washer and solvent solution are used to break down the asphalt binder and recover it. The remaining scrap material may be further “shredded” and reprocessed to obtain more asphalt binder, or the debris may be sorted into aggregate and fiber glass debris for further reclamation or reuse.

### Effects of the Methods Described Herein

This methods described herein allow removing all of the fine aggregate and a large portion of the residual asphalt binder from crushed asphalt. Almost 50% of the worst processing features may be removed. The methods described herein may be used as a first step in a two step method. That is the methods described herein may be a precursor to the methods described by Kotefski et al., U.S. Ser. No. 15/355,487, filed Nov. 18, 2016, teaching methods to reclaim or recycle asphalt or asphalt components to produce reusable asphalt or asphalt components by adding the asphalt or asphalt components to a solution at a temperature higher than the melting temperature of the asphalt binder. Using the methods described herein makes the combined process 10 to 20 times more effective in terms of energy usage, process foot print, equipment requirements, and overall need for oil and oil removal for reclamation.

Thereby the methods described herein reduce all of the fine aggregate processing needs and allows the second step of the reclaiming or recycling procedure, i.e. the boiling procedure, to only focus on the larger and medium aggregate. Thus, the amount of oil needed to process the large and medium aggregate is reduced by factors of 500% or more. The fine aggregates would fill the hot oil bath tanks and would need fresh oil more often. Additionally, the fine aggregates are worth more as an asphalt coated product than an uncoated product.

By employing the methods described herein in a two step process with those described in Kotefski et al., U.S. Ser. No. 15/355,487, filed Nov. 18, 2016, the total volume of oil required for the aggregate processing is reduced. Storage, transport and reprocessing at a refinery are eliminated for the fine aggregate components of the asphalt, and this provides a significant process improvement in terms of product cycle time, waste processing, waste control, energy usage and other benefits.

### Two Step Integrated Methods for Reclaiming or Recycling Asphalt Using Two Distinct Solvents or Solutions

The methods described herein may be followed by a second procedure or further methods to reclaim or recycle asphalt or asphalt components to produce reusable asphalt or asphalt components described herein including a) adding the asphalt or asphalt components obtained as described herein to a solution at a temperature higher than the melting temperature of the asphalt binder. The solution may be at least 300° F., 325° F., 350° F. or 400° F. or so. The solution may be an oil or petroleum base solution or any other suitable solution in which the asphalt binder is soluble.

An oil based solution acts as an environmental seal once introduced into the asphalt or asphalt components, i.e. coarse and fine aggregate. As it is submerged in the oil based solution, the asphalt binder is protected from degradation, burning and contamination. Current methods merely increase the asphalt temperature until the asphalt binder degrades because of the elevated temperature (not the dissolving into an oil based solvent). This elevated temperature tends to burn the asphalt binder to a degree that it is unusable or it merely degrades it so that there is no possibility of the asphalt binder performing as would a virgin asphalt mixture.

As the millings or reclaimed asphalt is introduced into the oil based solution, the asphalt binder phase changes from solid to liquid and quickly dilutes, mixes or integrates with the oil based solution. Motor oil or an equivalent is especially suitable because the solution can be safely elevated to temperatures over 500° F. Motor oil also has a low volatility potential under elevated temperatures. This potential oil based solutions and/or mixtures thereof may also include; gasoline, kerosene, diesel fuel and many others oil based products. Each oil based solvent has a “flash point” or level of volatility and could ignite or explode. Other non-oil based solutions may also be suitable including, for instance, waxes, low temperature metals, etc.

As the asphalt binder is dissolved into the oil based solution, the course and fine mineral aggregates are in a free state and are separated from the bond of the asphalt binder and mixture. With a subsequent separation or screening procedures, the coarse and fine aggregates can be separated and used as raw material for new asphalt mixtures. The separation or screening procedures may be performed at an elevated temperature range because separating the asphalt binder from the aggregates is best and most easily accomplished in a liquid state. Thus, all residual asphalt binder and oil based solution is able to drip off or can be spun off through a centrifugal spinning operation.

The second procedure or further methods to reclaim or recycle asphalt or asphalt components may also feature b) screening or separating coarse aggregate and fine aggregate asphalt components from the solution of a). The further methods may also feature c) cleaning or removing asphalt binder and/or the solution from the coarse aggregate and fine aggregate asphalt components screened or separated in step b). The cleaning or removing asphalt binder and/or the solution from the coarse aggregate and fine aggregate asphalt components may be performed by centrifugal spinning or by adding a second solution effective to remove the asphalt binder and/or the first solution.

The resultant separated asphalt composition is as follows:

(a) course aggregate coated with residual asphalt binder and oil based solution.

This constitutes 75% of the asphalt mass and is a valuable commodity in itself. Additionally, recycling this large percentage of the asphalt mixture provides environmental, energy, and equipment benefits.

(b) fine aggregate or sand/stone dust particulate coated with residual asphalt binder and oil based solution. Although this constitutes 10-20% of the total asphalt mixture, this recovered commodity has a higher value per pound than the coarse aggregate. Additionally, a pre-coated and screened fine aggregate has a further added value because it may be used in many other commodities.

(c) asphalt binder dissolved in the oil based solution. Although this solution is sludge, it has various polymer carbon chain molecules and would easily be recycled back into asphalt binder, mixes, roofing tar mixes, roofing shingle base materials, asphalt crack mixtures, driveway sealers, etc.

The coarse aggregate coated with residual asphalt binder and oil based solution may be cleaned. An added solvent cleaning operation can be applied to the coarse aggregate to remove the residual oil and asphalt binder. This coarse aggregate can then reused in a virgin asphalt mixture and used to produce asphalt that is equivalent to or superior to a virgin asphalt mixture because the reclaimed course aggregate has a pre-coated film of asphalt binder mixture thereof and binds better than virgin coarse aggregate. The virgin course aggregate that is not pre-coated with asphalt binder, thus a novel asphalt mixture is made that is superior to current mixtures using virgin materials. The pre-coating of the aggregate allows the asphalt binders to develop stronger bonds than the uncoated aggregate.

The coarse aggregate coated with residual asphalt binder and oil based solution may be cleaned by merely spinning off excess residual asphalt binder and oil based solution (in an elevated temperature and liquid state). The spinning procedure removes the residual asphalt binder and oil based solution material as well as provides a uniformly coated coarse aggregate. In this case, this pre-coated coarse aggregate may prove to bond better to the asphalt binder because it is pre-coated but not dry. It would contain a small amount of the oil base solution). This simplified process may be slightly substandard to the solvent cleaning method but it would still be superior to the current method of using virgin coarse aggregates.

The fine aggregate or crushed glass/sand/stone dust particulate coated with residual asphalt binder and oil based solution may also be cleaned as the coarse aggregate solvent and spinning methods described above for removing excess asphalt binder and residual solvent solution. A solvent may be used to remove the oil based solution and asphalt binder residual material. In this case it is more important than the coarse aggregate because the size of the fine aggregate may be dust or sand sized, and the excess or residual coating may have a mass that is equivalent or equal to the desired recovered commodity, i.e. sand, dust, crushed glass or other fine aggregate composition. Additional size screening may be performed to further segregate the fine aggregate into desired sizes since certain sizes or consistencies may be more valuable than virgin fine aggregate. A further advantage benefit of pre-coated fine aggregate may be realized because the fine aggregate provides the primary fill between the coarse aggregate. Their bond is important to the Asphalt mechanical properties. If the fine aggregate is pre-coated, then better grades of asphalt may be realized. In this case, the pre-coated fine aggregate is a by-product of the methods for reclaiming and recycling asphalt described herein.

The fine aggregate coated with residual asphalt binder and oil based solution may be cleaned by merely spinning as with the coarse aggregate. This too creates a better asphalt mixture because the asphalt binder bond to the fine aggregate is better and more repeatable in terms of bond strength from batch to batch. By having pre-coated fine aggregate, sand and dust particulate, other asphalt related products may be improved as well. For example, asphalt repair mixtures, crack fillers, roofing shingle compositions and various asphalt related products could be impacted. Presently, no pre-coated fine aggregate, sand, dust or crushed glass is available to the industry. The methods for reclaiming and recycling asphalt described herein may provide an improved material to these product lines.

The further methods for reclaiming and recycling asphalt described herein may further feature d) cleaning or removing asphalt binder from the solution of a). The asphalt binder dissolves in the oil based solution. The asphalt binder, normally a solid at room temperature, is now a liquid that is dissolved in the oil based solution. There are several options for using this mixture of asphalt binder and oil based solution. First, a screening process may be used to screen the heavy particulate from the oil based solution and reuse the oil based solution for further asphalt reclaiming and recycling. The sludge or residual asphalt binder may then be reclaimed and sent to a petroleum processing facility to breakdown the residual asphalt binder material back into various petroleum products such as motor oils, asphalt binders, roofing tar and roofing shingle materials. The oil based solution may be screened and reused multiple times by separating the thicker asphalt binder from the oil based solution.

### Benefits of the Asphalt Reclamation and Recycling Using the Two Step Integrated Methods

The methods described herein recycle each asphalt component including the coarse aggregate, fine aggregate and asphalt binder. Course aggregate constitutes 70-80% of asphalt volume. In being able to recover this material, a cost and environmental savings is realized. Coarse aggregate is basically crushed stone of varying sizes. Recovering the coarse aggregate from aged asphalt eliminates the need for new sources of coarse aggregate. The impact of this reclamation and recycling of coarse aggregate provides environmental and cost savings from (a) less need for or near elimination of need for new or virgin coarse aggregate supply, (b) less energy, man power, equipment and land costs required for obtaining the reclaimed versus virgin coarse aggregate, and (c); reduced need for federal, state and local regulation. Similarly, reclaiming or recycling fine aggregate would provide similar savings and improvements. Reclaiming or recycling the asphalt binder is the most challenging but in fact may prove to be the most needed.

The residual “sludge” produced by the methods for asphalt reclamation and recycling described herein is the asphalt binder in the oil based solution. It will likely need to be reclaimed at a petroleum reprocessing facility. On the other hand, oil supplies are dwindling and with potential oil shortages in the near future, the methods for asphalt reclamation and recycling also address potential oil shortages. In fact during recent oil shortages, the asphalt industry experienced potential shortages in asphalt binders (e.g. for roadways, parking facilities, roofing shingles, and tars. The methods for asphalt reclamation and recycling described herein are able to recycle current products and inventories back into a reusable form such that new sources of raw materials such as asphalt binders, asphalt repair mixtures, roofing shingle binders and roofing tars are recyclable to a large extent.

### Further Description of the Asphalt Reclamation and Recycling Two Step Integrated Methods

The methods for asphalt reclamation and recycling described herein provide a process that separates the main components of asphalt, i.e. coarse aggregate, fine aggregate and asphalt binder in such a way as to be fully recyclable to create an asphalt mixture that is equivalent or superior to virgin asphalt. Current asphalt recycling and reclamation efforts add aged or used asphalt (approx. 10-20%) to virgin asphalt. This new mixture is not comparable to virgin asphalt because in the asphalt blending, the aged asphalt retains some of its old asphalt binder and does not bond to the virgin asphalt binder in a homogeneous manner. Thus, asphalt product degradation occurs. This degraded form of asphalt may be adequate for driveways and parking lots, but for major uses such as roadways it may not meet performance requirements. Massive research and investigations have been made into this field, and no solutions have been provided previously.

The methods for asphalt reclamation and recycling described herein address this need and provide a way to meet the current best or virgin asphalt performance requirements by reclaiming or recycling aggregate from used asphalt. The methods for asphalt reclamation and recycling described herein are simple, grade the asphalt binder in such a way as not to leave asphalt binder on the coarse and fine aggregates that has crystallized, burned or added other impurities to the aggregates. Hence, the aggregates may be reused in another asphalt mixture. The methods for asphalt reclamation and recycling described herein simply dissolve the asphalt binder into a oil based solution while basically cleaning the aggregate from the asphalt binder.

In terms of volume and weight, more than 90% of an asphalt composition is the coarse and fine aggregates. This makes methods for asphalt reclamation and recycling described herein extremely effective in recovering the basic raw materials needed for future asphalt production. The second procedure or further methods to reclaim or recycle asphalt or asphalt components described herein may be described by the following steps:

1. Provide any asphalt, or chunks, millings or particulate of asphalt. The existing asphalt may be milled or ground into suitable sized chunks or pieces.

2. Add the asphalt, or chunks, millings or particulate of asphalt to an oil based solution at a melting temperature of the asphalt binder (approximately 350-400° F.). The solution is preferably oil or petroleum based because the asphalt binder is oil based as well.

3. The oil based solution acts as an environmental seal such that the asphalt or chunks, millings or particulate of asphalt introduced into the solution does not “burn” but rather dissolves into the oil based solution. A suitable solution may be, for instance, motor oil.

4. As the asphalt, or chunks, millings or particulate of asphalt is introduced into the oil based solution, the asphalt binder changes phase from a solid to a liquid and quickly mixes or integrates with the oil based solution without serious damage (burning) to the asphalt binder.

5. As the Binder is dissolved into the oil based solution, the coarse and fine mineral aggregates are in a free state or separated from the previous bonded asphalt mixture.

6. Any suitable sequence of screening may be performed so that the coarse and fine aggregates can be separated. This separation may be performed at the elevated temperature since the asphalt binder separation is most effectively performed with the asphalt binder in a liquid state.

7. The resulting separated asphalt composition is as follows;
a. course aggregate coated with residual asphalt binder and oil based solution
b. fine aggregate or sand/dust particulate coated with residual asphalt binder and oil based solution
c. asphalt binder dissolved in the oil based solution.

We claim:

1. A method to reclaim or recycle asphalt or asphalt components to produce reusable asphalt or asphalt components comprising
(a) providing crushed asphalt or asphalt components; and
(b) adding the asphalt or asphalt components to a solvent in which the asphalt binder is soluble.

2. The method according to claim 1 wherein the solvent is provided at approximately ambient temperature.

3. The method according to claim 1 wherein the solvent is selected from the group consisting of heptane, hexane, naphta, kerosene, gasoline or a petroleum based solvent.

4. The method according to claim 1 wherein the solvent is provided in an automated parts washer.

5. The method according to claim 1 further comprising grinding or breaking the asphalt to be reclaimed or recycled into chunks, millings or particulate prior to step a).

6. The method according to claim 1 further comprising
c) screening or separating coarse aggregate and fine aggregate asphalt components from the solution of b).

7. The method according to claim 1 further comprising
d) cleaning or removing asphalt binder and/or the solvent from the coarse aggregate and fine aggregate asphalt components screened or separated in step c).

8. The method according to claim 7 wherein the cleaning or removing asphalt binder and/or the solution from the coarse aggregate and fine aggregate asphalt components is performed by centrifugal spinning or by adding a second solution effective to remove the asphalt binder and/or the first solution.

9. The method according to claim 1 further comprising
e) cleaning or removing asphalt binder from the solution of b).

10. A reclaimed asphalt or asphalt component reclaimed or recycled according to the method of claim 1.

11. The reclaimed asphalt component of claim 10 comprising one or more components selected from the group consisting of a coarse or mineral aggregate, a fine aggregate and an asphalt binder.

12. The reclaimed asphalt component of claim 11 featuring binding properties for binding to an asphalt binder that are superior to the binding properties of virgin asphalt or virgin asphalt components.

13. The reclaimed coarse or mineral aggregate of claim 11 wherein the coarse or mineral aggregate is substantially coated with asphalt binder or the solvent.

14. The reclaimed fine aggregate of claim 11 wherein the fine aggregate is substantially coated with asphalt binder or the solvent.

15. The reclaimed asphalt binder of claim 11 wherein the asphalt binder is a liquid dissolved in the solvent.

16. The method according to claim 1 effective to remove at least 25% of asphalt binder from the crushed asphalt or asphalt components.

17. A two step integrated method to reclaim or recycle asphalt or asphalt components to produce reusable asphalt or asphalt components comprising:
(a) providing crushed asphalt or asphalt components;
(b) adding the asphalt or asphalt components to a solvent in which the asphalt binder is soluble;
(c) screening or separating coarse aggregate and fine aggregate asphalt components from the solution of b);
(d) adding the asphalt components obtained from c) to a solution at a temperature higher than the melting temperature of the asphalt binder;
(e) screening or separating coarse aggregate and fine aggregate asphalt components from the solution of d); and
(f) cleaning or removing asphalt binder and/or the solution from the coarse aggregate and fine aggregate asphalt components screened or separated in step e).

18. The method of claim 17 further comprising g) cleaning or removing asphalt binder from the solution of d).

19. The method of claim 17 wherein the solvent of b) is provided at about ambient temperature in an automated parts washer.

20. The method of claim 17 wherein the solution of d) is at least 350° F.
